(19) United States
(12) Patent Application Publication
(10) Pub. No.: US 2020/0089259 A1
(43) Pub. Date: Mar. 19, 2020

(54) COURSE CORRECTION METHOD AND DEVICE, AND AIRCRAFT

(71) Applicant: SZ DJI TECHNOLOGY CO., LTD., Shenzhen (CN)

(72) Inventor: Kang WANG, Shenzhen (CN)

(21) Appl. No.: 16/690,111

(22) Filed: Nov. 20, 2019

Related U.S. Application Data
(63) Continuation of application No. PCT/CN2017/085465, filed on May 23, 2017.

(51) Int. Cl. G05D 1/10; G05D 1/08; B64C 39/02

(52) U.S. Cl. CPC G05D 1/101; B64C 2201/141; B64C 39/02; G05D 1/08

(57) ABSTRACT

A method for correcting a course of an aircraft includes obtaining a flight velocity of the aircraft in a horizontal direction at a current time instance and acceleration data of the aircraft at the current time instance during a course movement of the aircraft. The method also includes correcting the acceleration data based on the flight velocity in the horizontal direction at the current time instance to obtain corrected acceleration data. The method further includes controlling a flight velocity of the aircraft in the horizontal direction based on the corrected acceleration data.

### CROSS-REFERENCE TO RELATED APPLICATION

This application is a continuation application of International Application No. PCT/CN2017/085465, filed on May 23, 2017, the entire content of which is incorporated herein by reference.

### TECHNICAL FIELD

The present disclosure relates to the technology field of controls and, more particularly, to a course correction method and device, and an aircraft.

### BACKGROUND

With the advancement of unmanned aircraft, unmanned aircrafts have been widely used in various fields. The requirement on the control precision of the unmanned aircrafts has become increasingly higher. In a control process of the unmanned aircraft, there is a typical control operation: the unmanned aircraft receives a flight direction control command transmitted by a control terminal, and the unmanned aircraft maintains the current location unchanged, or change the flight direction of the unmanned aircraft based on the flight direction control command, i.e., control the unmanned aircraft to perform a course movement.

However, in current technologies, for this control operation, during the process of the unmanned aircraft continuously changing the course, due to the deviation in data output by a sensor caused by a mounting error of the sensor (e.g., an accelerometer), a velocity may exist in the horizontal direction of the unmanned aircraft. This may cause the unmanned aircraft to not only adjust the course during the course changing process, but also to circle around a location point at a relatively small radius. Accordingly, the performance of the unmanned aircraft in maintaining the location unchanged while adjusting the course may be degraded.

### SUMMARY

In accordance with an aspect of the present disclosure, there is provided a method for correcting a course of an aircraft. The method includes obtaining a flight velocity of the aircraft in a horizontal direction at a current time instance and acceleration data of the aircraft at the current time instance during a course movement of the aircraft. The method also includes correcting the acceleration data based on the flight velocity in the horizontal direction at the current time instance to obtain corrected acceleration data. The method further includes controlling a flight velocity of the aircraft in the horizontal direction based on the corrected acceleration data.

In accordance with another aspect of the present disclosure, there is provided a device for correcting a course of an aircraft. The device includes a velocity sensor and an accelerometer. The device also includes a processor. The velocity sensor is configured to obtain a flight velocity of the aircraft in a horizontal direction at a current time instance and transmit the flight velocity to the processor during a course movement of the aircraft. The accelerometer is configured to obtain acceleration data of the aircraft at the current time instance and transmit the acceleration data to the processor during the course movement of the aircraft. The processor is configured to correct the acceleration data based on the flight velocity of the aircraft in the horizontal direction at the current time instance to obtain corrected acceleration data. The processor is also configured to control a flight velocity of the aircraft in the horizontal direction based on the corrected acceleration data.

According to the technical solutions of the disclosed course correction method and device, and the aircraft, during the course movement of the aircraft, a flight velocity of the aircraft in the horizontal direction and acceleration data of the aircraft at a current time instance may be obtained. The acceleration of the aircraft may be corrected based on the flight velocity at the current time instance to obtain corrected acceleration data. The flight velocity of the aircraft in the horizontal direction may be controlled based on the corrected acceleration data such that a flight velocity of the aircraft in the horizontal direction for a next time instance is smaller than the flight velocity of the aircraft in the horizontal direction at the current time instance. Through the above course correction process, when the aircraft performs the course movement, a velocity of the aircraft in the horizontal direction may be effectively reduced, i.e., the radius at which the aircraft circles around a location point may be reduced. As such, the performance of the unmanned aircraft in maintaining the location unchanged while only adjusting the course may be enhanced, thereby improving the flexibility and safety of the aircraft in various applications.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a schematic illustration of a flight path of an unmanned aircraft F circles around a point A, according to an example embodiment.

FIG. 2 is a flow chart illustrating a method for correcting a course of an aircraft, according to an example embodiment.

FIG. 3 is a schematic illustration of an aircraft body coordinate system OXYZ, according to an example embodiment.

FIG. 4 is a flow chart illustrating a method for correcting a course of an aircraft, according to another example embodiment.

FIG. 5 is a flow chart illustrating a method for correcting a course of an aircraft, according to another example embodiment.

FIG. 6 is a flow chart illustrating a method for correcting a course of an aircraft, according to another example embodiment.

FIG. 6A is a schematic illustration of a rotation conversion of acceleration data around a Y axis of the accelerometer, according to an example embodiment.

FIG. 6B is a schematic illustration of a rotation conversion of rotation-converted acceleration data around an X axis of the accelerometer, according to an example embodiment.

FIG. 7 is a schematic diagram of a course correction device, according to an example embodiment.

FIG. 8 is a schematic diagram of a course correction device, according to another example embodiment.

FIG. 9 is a schematic diagram of an unmanned aircraft, according to an example embodiment.

### LIST OF ELEMENTS

F—unmanned aircraft

700—course correction device

701—velocity sensor

702—accelerometer

703—processor

704—communication interface

901—aircraft body

902—propulsion system

903—course correction device

1000—control terminal

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a processor, a portion of a processor, an algorithm, a portion of an algorithm, a circuit, a portion of a circuit, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Next, the embodiments of the present disclosure will be described in detail. Unless there is obvious conflict, the various embodiments or various features of various embodiments may be combined.

For an aircraft, particularly an unmanned aircraft, during a course control process, a user may transmit a course control command to the aircraft through a course button or a course joystick of a control terminal, such that the aircraft adjust the course (e.g., flight direction) while maintaining the current location unchanged.

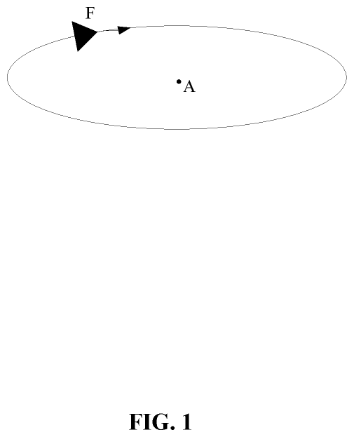

As shown in FIG. 1, in an ideal situation, when receiving the course control command transmitted by the control terminal, the unmanned aircraft may adjust the course based on the control command. During the course movement of the unmanned aircraft, the unmanned aircraft may maintain its location unchanged, and only performs the course movement. Because the location remains unchanged, the velocity of the unmanned aircraft in the horizontal direction is zero. In other words, there is no velocity in the horizontal direction for the unmanned aircraft. However, in a practical situation, due to a mounting error of a sensor, deviation may exist in the output data of the sensor. When the processor of the unmanned aircraft controls the unmanned aircraft based on the output data having the deviation, the velocity of the unmanned aircraft in the horizontal direction is not 0 during the course movement process. That is, as shown in FIG. 1, the unmanned aircraft F may circle (or circle-fly) around a location point A as a center point with a relatively small radius, demonstrating a circle drawing around a fixed center point phenomenon.

As such, to effectively enhance the performance of the unmanned aircraft in maintaining the location unchanged and only adjusting the course, and to improve the flexibility and safety of the aircraft in various applications, the present disclosure provides a course correction technical solution.

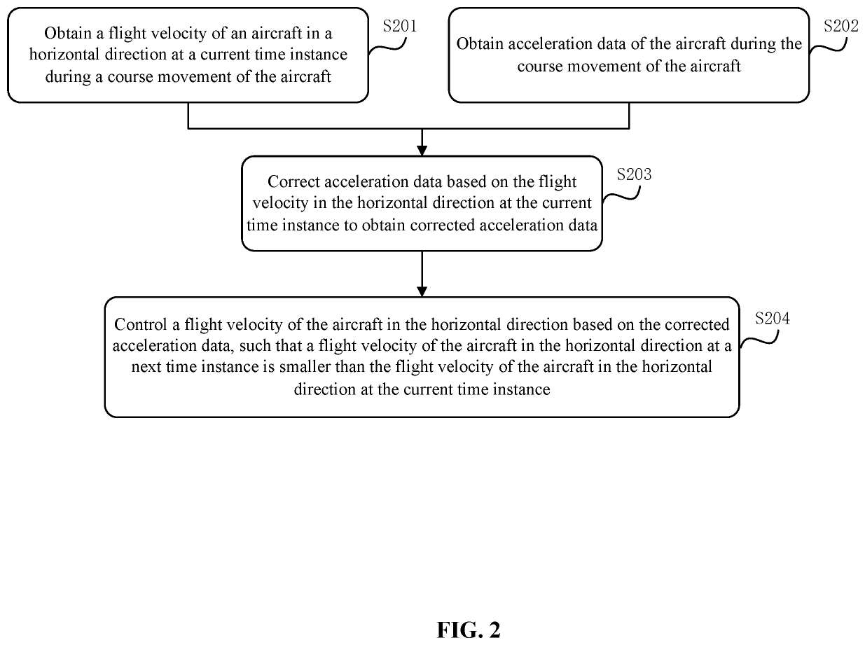

FIG. 2 is a flow chart illustrating a course correction method (or a method for correcting a course of an aircraft). The course correction method will be described in detail with reference to FIG. 2, which can effectively enhance the performance of the unmanned aircraft in maintaining its location unchanged and only adjusting the course. As shown in FIG. 2, the method may include:

Step S201: obtaining a flight velocity of an aircraft in a horizontal direction at a current time instance during a course movement of the aircraft.

In some embodiments, the entity for executing the step S201 may be a velocity sensor configured to sense a flight velocity of the aircraft in a horizontal direction. The velocity sensor may be any suitable sensor that is configured to sense the flight velocity of the aircraft in the horizontal direction, such as a vision sensor (a monocular vision sensing system, a binocular stereoscopic vision sensing system), a time of flight (“TOF”) camera, a radar, a light detection and ranging (“Lidar”), a global positioning system (“GPS”), etc., which is not limited by the present disclosure.

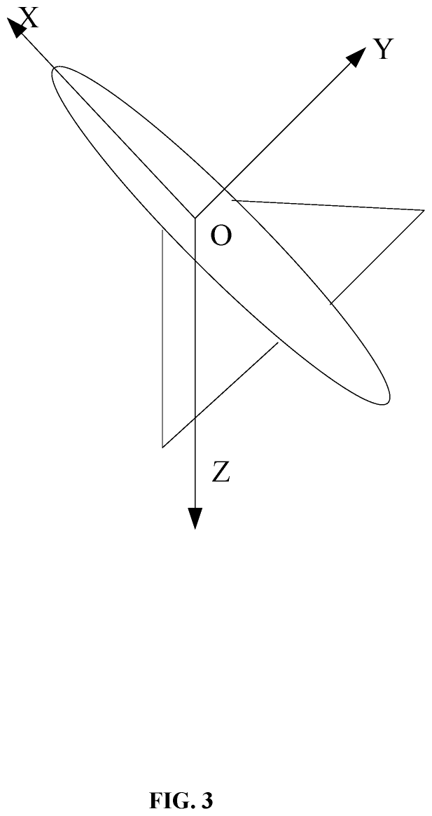

It is noted that FIG. 3 schematically illustrates an aircraft body coordinate system. When the aircraft only performs the course movement, an XOY plane of the aircraft body coordinate system of the aircraft is parallel with a horizontal plane. The velocity in the horizontal direction may include a flight velocity in an X axis direction and a flight velocity in a Y axis direction in the aircraft body coordinate system.

Step S202: obtaining acceleration data of the aircraft during the course movement of the aircraft.

In some embodiments, the entity for executing step S202 may be an accelerometer. The accelerometer of the present disclosure may be any suitable sensor configured to detect an acceleration. The accelerometer may be a single-axis accelerometer, a dual-axis accelerometer, or a three-axis accelerometer.

For illustrative purposes, a three-axis accelerometer is used as an example of the accelerometer in the following descriptions. Currently, the accelerometer and a gyroscope may be integrated as a single module, i.e., the inertial measurement unit (“IMU”), which may be fixedly mounted inside the body of the unmanned aircraft.

It is noted that the steps S201 and S202 may be executed in any order. During an operation of the aircraft, each step separately acquires the velocity and acceleration.

Step S203: correcting acceleration data based on the flight velocity in the horizontal direction at the current time instance to obtain corrected acceleration data.

In some embodiments, the entity for executing the step S203 may be a processor. The processor may be or be part of a flight control system of the unmanned aircraft, or may be other dedicated or generic processor that has data processing capability, which is not limited in the present disclosure.

In some embodiments, when the mounting state of the accelerometer is an ideal mounting state, i.e., there is no mounting error in the accelerometer, an XOY plane formed by an X axis and a Y axis of the accelerometer is parallel with the horizontal plane. The coordinate system of the accelerometer and the aircraft body coordinate system of the unmanned aircraft are the same. Then, when the unmanned aircraft performs the course movement, acceleration data output by the accelerometer are 0. That is, acceleration data output by the accelerometer in all three axes (X axis, Y axis, and Z axis) are all 0. However, because there is a mounting error in the accelerometer, the acceleration data output in the three axes (X axis, Y axis, and Z axis) are not all 0. That is, there is an error in the acceleration data output by the accelerometer. Because the acceleration output by the accelerometer is a critical parameter in controlling the velocity of the unmanned aircraft, as described above, because there is an error in the acceleration data output by the accelerometer, there is a need to correct the acceleration data output by the accelerometer to obtain corrected acceleration data.

Step S204: controlling a flight velocity of the aircraft in the horizontal direction based on the corrected acceleration data, such that a flight velocity of the aircraft in the horizontal direction at a next time instance is smaller than the flight velocity of the aircraft in the horizontal direction at the current time instance.

In some embodiments, the entity for executing the step S204 may be the above-described processor. Based on the above descriptions, after the processor obtains the corrected acceleration data, the processor may control the flight velocity of the aircraft in the horizontal direction based on the corrected acceleration data. As compared to the acceleration data before correction, the corrected acceleration data reduces the error in the acceleration data. As such, the flight velocity of the aircraft in the horizontal direction in the next time instance may be smaller than the flight velocity of the aircraft in the horizontal direction at the current time instance. The disclosed method may effectively reduce the change of the velocity of the aircraft in the horizontal direction.

In some embodiments, the control terminal described above may be a remote controller, a smart cell phone, a tablet, a ground-based control station, a laptop, a wearable device (e.g., a watch, a wristband), or a combination thereof.

In the technical solutions of the present disclosure, during the course movement of the aircraft, a flight velocity of the aircraft in the horizontal direction and the acceleration data of the aircraft at the current time instance may be obtained. The acceleration of the aircraft may be corrected based on the flight velocity at the current time instance to obtain corrected acceleration data. The flight velocity of the aircraft in the horizontal direction may be controlled based on the corrected acceleration data, such that a flight velocity of the aircraft in the horizontal direction at a next time instance is smaller than the flight velocity of the aircraft in the horizontal direction at the current time instance. Through the above course correction process, when the aircraft performs a course movement, a velocity of the aircraft in the horizontal direction may be effectively reduced, i.e., the radius at which the aircraft circles around a location point may be reduced. As a result, during the course movement, the aircraft may maintain the location unchanged. The disclosed method may enhance the performance of the unmanned aircraft in maintaining the location unchanged and only adjusting the course, and improve the flexibility and safety of the aircraft in various applications.

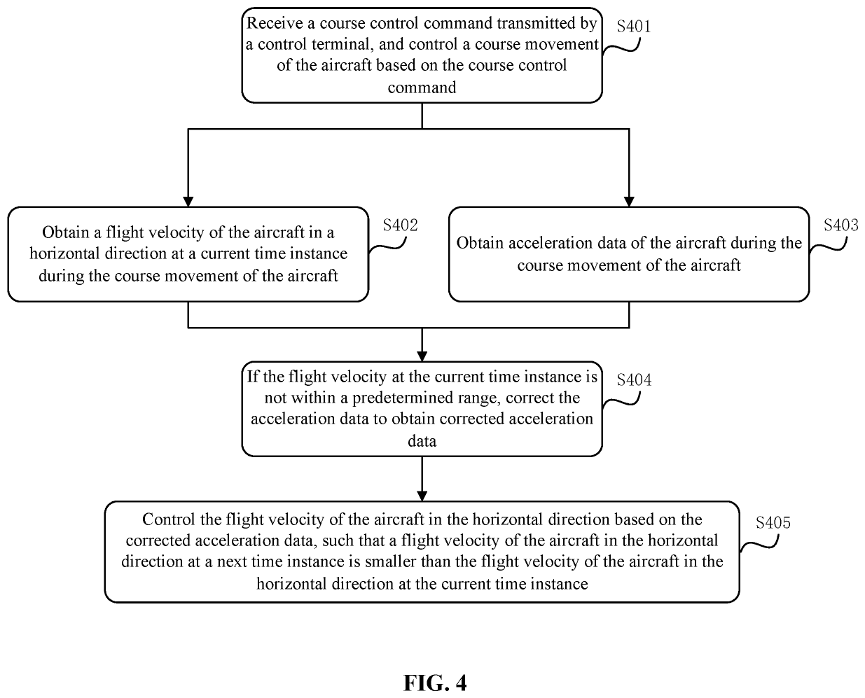

The present disclosure provides a course correction method. On the basis of the embodiment shown in FIG. 2, FIG. 4 is a flow chart illustrating another embodiment of a course correction method. In the embodiment shown in FIG. 4, the method may include:

Step S401: receiving a course control command transmitted by a control terminal, and controlling a course movement of the aircraft based on the course control command.

In some embodiments, a user may transmit the course control command to the unmanned aircraft through the control terminal. For example, the user may operate a course joystick of the control terminal. The control terminal may transmit the course control command to the unmanned aircraft. After receiving the course control command, the unmanned aircraft may adjust the course based on the course control command, i.e., perform the course movement based on the course control command.

Step S402: obtaining a flight velocity of the aircraft in a horizontal direction at a current time instance during the course movement of the aircraft.

In some embodiments, the entity for executing the step S402 and the principle of the execution may be the same as those of step S201 shown in FIG. 2. Detailed descriptions of step S402 can refer to the descriptions of step S201, which are not repeated.

Based on the aircraft body coordinate system shown in FIG. 3, it can be known that in some embodiments the flight velocity of the aircraft in the horizontal direction may include a velocity of the aircraft in the X axis direction and a velocity of the aircraft in the Y axis direction in the aircraft body coordinate system.

Step S403: obtaining acceleration data of the aircraft during the course movement of the aircraft.

In some embodiments, the entity for executing the step S403 and the principle of the execution may be the same as those of step S202 shown in FIG. 2. Detailed descriptions of step S403 can refer to the descriptions of step S202, which are not repeated.

Step S404: if the flight velocity at the current time instance is not within a predetermined range, correcting the acceleration data to obtain corrected acceleration data.

In some embodiments, when the processor obtains the flight velocity at the current time instance, the processor may compare the flight velocity with a predetermined velocity value to determine whether the flight velocity is within the predetermined range. When the flight velocity is greater than or equal to the predetermined velocity value, i.e., when the flight velocity at the current time instance is not within the predetermined range, it indicates that the flight velocity of the unmanned aircraft in the horizontal direction is relatively large. When performing the course movement, the performance of the unmanned aircraft in maintaining the location unchanged is relatively poor. It may be desirable to correct the acceleration data output by the accelerometer, and to control the flight velocity based on the corrected acceleration data such that the flight velocity of the unmanned aircraft in the horizontal direction may be reduced. When the flight velocity at the current time instance is smaller than the predetermined velocity value, i.e., the flight velocity at the current time instance is within the predetermined range, it indicates that the flight velocity of the unmanned aircraft in the horizontal direction is relatively small. When performing the course movement, the performance of the unmanned aircraft in maintaining the location unchanged may be relatively good, and it may not need to correct the acceleration data output by the accelerometer.

In some embodiments, the flight velocity at the current time instance being not within the predetermined range may include the following situation: a velocity in the X axis direction and a velocity in the Y axis direction in the aircraft body coordinate system at the current time instance are not within the predetermined range. For example, if the velocity in the X axis direction and the velocity in the Y axis direction in the aircraft body coordinate system at the current time instance are greater than or equal to the predetermined velocity value, i.e., if the velocity in the X axis direction and the velocity in the Y axis direction in the aircraft body coordinate system at the current time instance are not within the predetermined range, such as when the velocity in the X axis direction and the velocity in the Y axis direction in the aircraft body coordinate system at the current time instance are greater than or equal to 3 cm/s, it may indicate that the flight velocity of the unmanned aircraft in the horizontal direction is relatively large. When performing the course movement, the performance of the unmanned aircraft in maintaining the location unchanged may be relatively poor. It may be desirable to control the flight velocity in the horizontal direction based on the above-described method. When the velocity in the X axis direction and the velocity in the Y axis direction in the aircraft body coordinate system at the current time instance are smaller than the predetermined velocity value, i.e., when the velocity in the X axis direction and the velocity in the Y axis direction in the aircraft body coordinate system at the current time instance are within the predetermined range, such as when velocity in the X axis direction and the velocity in the Y axis direction in the aircraft body coordinate system at the current time instance are smaller than 3 cm/s, it may indicate that the flight velocity of the unmanned aircraft in the horizontal direction is relatively small. When performing the course movement, the performance of the unmanned aircraft in maintaining the location unchanged is relatively good, and it may not be desirable to correct the acceleration data output by the accelerometer.

In some embodiments, the 3 cm/s predetermined velocity value is only for illustration purposes. A person having ordinary skills in the art can select other predetermined velocity value, which is not limited by the present disclosure.

Step S405: controlling the flight velocity of the aircraft in the horizontal direction based on the corrected acceleration data, such that a flight velocity of the aircraft in the horizontal direction at a next time instance is smaller than the flight velocity of the aircraft in the horizontal direction at the current time instance.

In some embodiments, the entity for executing step S405 and the execution principle may be the same as those for step S204. Thus, the descriptions of step S405 may refer to the descriptions of step 204, which are not repeated.

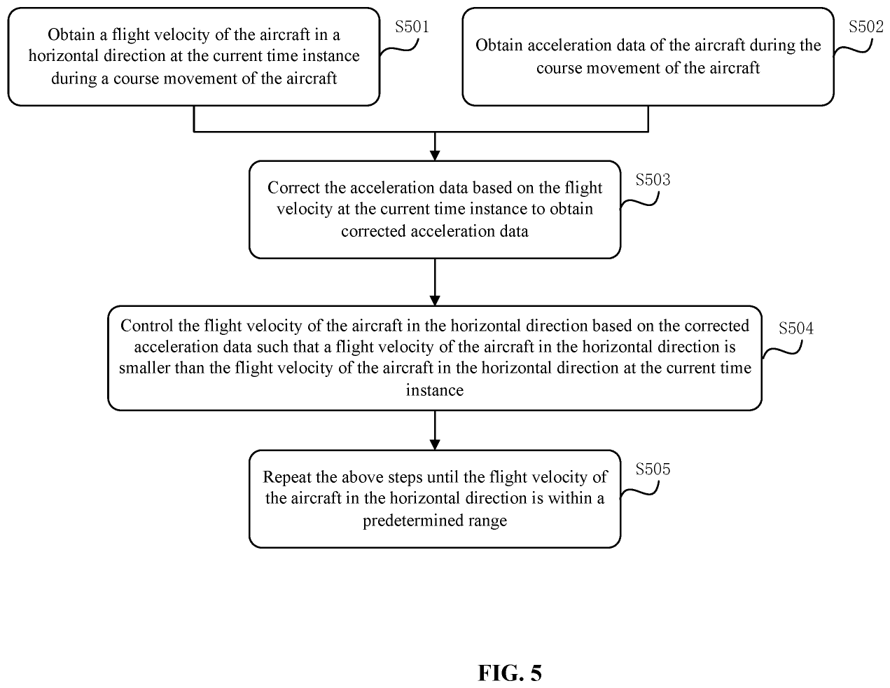

The present disclosure provides a course correction method. On the basis of the embodiments shown in FIG. 2 and FIG. 4, FIG. 5 is a flow chart illustrating another course correction method. The method shown in FIG. 5 may include:

Step S501: obtaining a flight velocity of the aircraft in a horizontal direction at the current time instance during a course movement of the aircraft.

In some embodiments, the entity for executing step S501 and the execution principle may be the same as those of step S201 shown in FIG. 2. Thus, descriptions of step S501 can refer to the descriptions of step S201, which are not repeated.

It is noted that from the aircraft body coordinate system shown in FIG. 3, it can be known that the flight velocity of the aircraft in the horizontal direction may include a velocity of the aircraft in the X axis direction and a velocity of the aircraft in the Y axis direction in the aircraft body coordinate system.

Step S502: obtaining acceleration data of the aircraft during the course movement of the aircraft.

In some embodiments, the entity for executing step S502 and the execution principle may be the same as those of step S202 shown in FIG. 2. Thus, descriptions of step S502 can refer to the descriptions of step S202, which are not repeated.

Step S503: correcting the acceleration data based on the flight velocity at the current time instance to obtain corrected acceleration data;

Step S504: controlling the flight velocity of the aircraft in the horizontal direction based on the corrected acceleration data such that a flight velocity of the aircraft in the horizontal direction is smaller than the flight velocity of the aircraft in the horizontal direction at the current time instance.

Step S505: repeating the above steps until the flight velocity of the aircraft in the horizontal direction is within a predetermined range.

In some embodiments, steps S501-S504 are operations for controlling the flight velocity of the aircraft in the horizontal direction based on the corrected acceleration data. At a next time instance (when at the next time instance, the next time instance is the current time instance of steps S501-S504), steps S501-S504 are repeated, until at the next time instance, the flight velocity of the unmanned aircraft in the horizontal direction output by a velocity sensor is within the predetermined range, for example, when the velocity of the aircraft in the X axis direction and the velocity of the aircraft in the Y axis direction in the aircraft body coordinate system are both smaller than 3 cm/s. By controlling for multiple times the flight velocity of the unmanned aircraft in the horizontal direction based on the corrected acceleration data, the flight velocity of the unmanned aircraft in the horizontal direction may be reduced gradually. When the unmanned aircraft performs the course movement, the performance of maintaining location unchanged may be gradually enhanced. When the flight velocity of the unmanned aircraft in the horizontal direction is smaller than the predetermined velocity value, it can be deemed that when the unmanned aircraft performs the course movement, the performance of maintaining the location unchanged has reached a predetermined criterion.

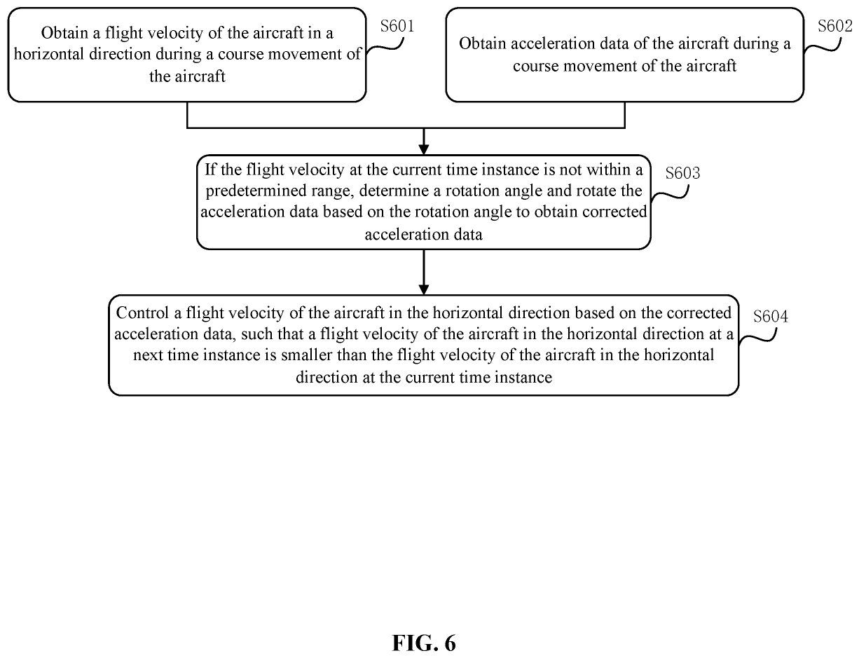

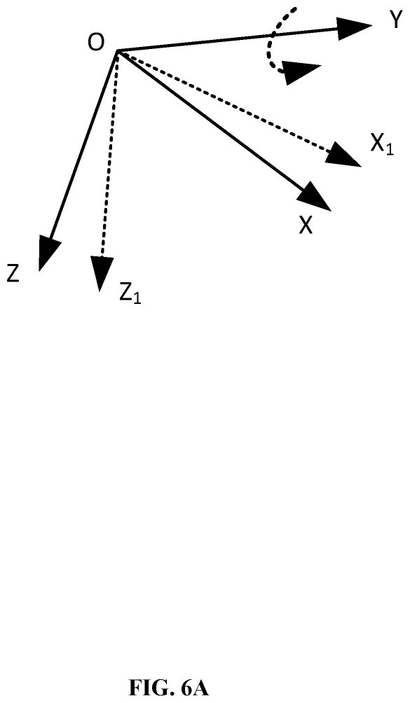

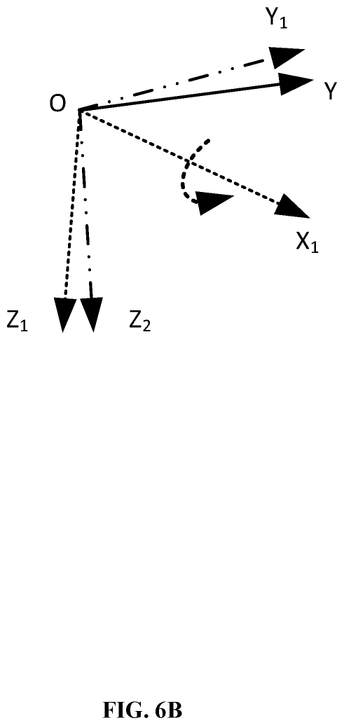

The present disclosure provides a course correction method. On the basis of the embodiments shown in FIG. 2, FIG. 4, and FIG. 5, FIG. 6 is a flow chart illustrating another course correction method. The method shown in FIG. 6 may include:

Step S601: obtaining a flight velocity of the aircraft in a horizontal direction during a course movement of the aircraft.

In some embodiments, the entity for executing step S601 and the execution principle may be the same as those of step S201 shown in FIG. 2. Thus, descriptions of step S601 can refer to the descriptions of step S201, which are not repeated.

It is noted that it can be known from the aircraft body coordinate system shown in FIG. 3, the flight velocity of the aircraft in the horizontal direction may include a velocity of the aircraft in the X axis direction and a velocity of the aircraft in the Y axis direction in the aircraft body coordinate system.

Step S602: obtaining acceleration data of the aircraft during a course movement of the aircraft.

In some embodiments, the entity for executing step S602 and the execution principle may be the same as those of the step S202 shown in FIG. 2. Thus, descriptions of step S602 can refer to the descriptions of step S202, which are not repeated.

Step S603: if the flight velocity at the current time instance is not within a predetermined range, determining a rotation angle and rotating the acceleration data based on the rotation angle to obtain corrected acceleration data.

In some embodiments, determining the rotation angle and rotating the acceleration data based on the rotation angle to obtain corrected acceleration data may be implemented through one or more of the following practical methods:

In a first practical method:

determining the rotation angle at the current time instance based on the flight velocity of the aircraft in the horizontal direction at the current time instance, and rotating the acceleration data based on the rotation angle to obtain corrected acceleration data. Each time when the acceleration data are rotation-corrected, the rotation angle may be determined based on the flight velocity. The flight velocity of the aircraft in the horizontal direction at the current time instance may include a flight velocity of the aircraft in the X axis direction and a flight velocity of the aircraft in the Y axis direction in the aircraft body coordinate system.

In some embodiments, the first practical method may include determining a first rotation angle at the current time instance based on a velocity in the X axis direction in the aircraft body coordinate system, and determining a second rotation angle at the current time instance based on a velocity in the Y axis direction in the aircraft body coordinate system; and rotating the acceleration data based on the first rotation angle and the second rotation angle to obtain corrected acceleration data.

Next, detailed descriptions will be provided for the process of determining the first rotation angle at the current time instance based on the velocity in the X axis direction in the aircraft body coordinate system, and determining the second rotation angle at the current time instance based on the velocity in the Y axis direction in the aircraft body coordinate system:

determining a first rotation angle correction amount at the current time instance based on the velocity in the X axis direction in the aircraft body coordinate system, and determining the first rotation angle at the current time instance based on the first rotation angle correction amount and a first rotation angle at a previous time instance prior to the current time instance; and determining a second rotation angle correction amount at the current time instance based on the velocity in the Y axis direction in the aircraft body coordinate system, and determining the second rotation angle at the current time instance based on the second rotation angle correction amount and a second rotation angle of the previous time instance prior to the current time instance. For example, at k=0 time instance, the flight velocity in the X axis direction Vₓ₀ and the flight velocity in the Y axis direction V_{y0} and the acceleration data output by the accelerometer at the current time instance may be obtained. The flight velocities Vₓ₀ and V_{y0} at the current time instance may not be within a predetermined range. A first rotation angle correction amount may be determined based on Vₓ₀ to be k*Vₓ₀. The first rotation angle may be determined as αₓ₀=k*Vₓ₀. The second rotation angle correction amount may be determined based on V_{y0} to be k*V_{y0}. The second rotation angle may be determined as α_{y0}=k*V_{y0}. The acceleration data may be rotated (or converted by rotation) based on the first rotation angle αₓ₀ and the second rotation angle α_{y0} to obtain corrected acceleration data. The flight velocity may be controlled based on the corrected acceleration data such that the flight velocity at the time instance k=1 is smaller than the flight velocity at current time instance (k=0).

In some embodiments, at time instance k=1, a flight velocity Vₓ₁ in the X axis direction at the current time instance (k=1), a flight velocity V_{y1} in the Y axis direction at the current time instance (k=1), and the acceleration data output by the accelerometer may be obtained. When the flight velocities Vₓ₁ and V_{y1} at the current time instance are not within a predetermined range, a first rotation angle correction amount may be determined based on Vₓ₁ to be k*Vₓ₁. A first rotation angle at time instance k=1 may be a sum of a first rotation angle at time instance k=0 and the first rotation angle correction amount at the current time instance (k=1), i.e., αₓ₁=αₓ₀+k*Vₓ₁. A second rotation angle correction amount may be determined based on V_{y1} to be k*V_{y1}. The second rotation angle at time instance k=1 may be a sum of a second rotation angle at time instance k=0 and the second rotation angle correction amount at the current time instance (k=1), i.e., α_{y1}=α_{y0}k*V_{y1}. The acceleration data may be rotated based on the first rotation angle αₓ₁ and the second rotation angle α_{y1} to obtain corrected acceleration data. The flight velocity may be controlled based on the corrected acceleration data such that the flight velocity at time instance k=2 is smaller than the flight velocity at the current time instance (k=1).

In some embodiments, at time instance k=2, a flight velocity Vₓ₂ in the X axis direction, a flight velocity V_{y2} in the Y axis direction, and acceleration data output by the accelerometer at the current time instance may be obtained. When the flight velocity Vₓ₂ and V_{y2} at the current time instance are not within a predetermined range, a first rotation angle correction amount may be determined based on Vₓ₂ to be k*Vₓ₂. The first rotation angle is a sum of the rotation angle at time instance k=1 and the first rotation angle correction amount at the current time instance, i.e., αₓ₂=αₓ₁+k*Vₓ₂. A second rotation angle correction amount may be determined based on V_{y2} to be k*V_{y2}. The second rotation angle is a sum of the rotation angle at time instance k=1 and the second rotation angle correction amount at the current time instance, i.e., α_{y2}=α_{y1}+k*V_{y2}. The acceleration data may be rotated based on the first rotation angle αₓ₂ and the second rotation angle α_{y2} to obtain corrected acceleration data. The flight velocity may be controlled based on the corrected acceleration data such that the flight velocity at time instance k=3 is smaller than the flight velocity at the current time instance.

Similar processes may be repeated until the flight velocity at the next time instance is within the predetermined range, i.e., until the flight velocity at the next time instance is smaller than the predetermined velocity value.

It is noted that the rotation angle correction amount being a production of k and the flight velocity is only one implementation method. A person having ordinary skills in the art can adopt other methods to determine the rotation angle correction amount based on the flight velocity, which are not limited by the present disclosure.

In some embodiments, one or more of the following practical methods may be used to implement the step of rotating the acceleration data based on the first rotation angle and the second rotation angle to obtain corrected acceleration data:

In one practical method: rotating the acceleration data around the Y axis of the accelerometer based on the first rotation angle to obtain rotation-converted acceleration data; and rotating the rotation-converted acceleration data around the Y axis of the accelerometer based on the second rotation angle to convert into corrected acceleration data.

In some embodiments, as shown in FIG. 6A, the acceleration data output by the accelerometer at the current time instance may be (a_{a,1}, a_{y,1}, a_{z,1}), the first rotation angle at the current time instance may be determined as α, the acceleration data may be rotated around the Y axis of the accelerometer based on the first rotation angle α to obtain rotation-converted acceleration data (a_{x,1} cos α−a_{z,1} sin α, a_{y,1}, a_{x,1} sin α+a_{z,1} cos α). The detailed rotation conversion may be implemented as follows:

$$[ \begin{matrix}{a}_{x , 2} \\ {a}_{y , 2} \\ {a}_{z , 2}\end{matrix} ] = [ \begin{matrix}cos α & 0 & sin α \\ 0 & 1 & 0 \\ - sin α & 0 & cos α\end{matrix} ] [ \begin{matrix}{a}_{x , 1} \\ {a}_{y , 1} \\ {a}_{z , 1}\end{matrix} ] = [ \begin{matrix}{a}_{x , 1} cos α + {a}_{z , 1} sin α \\ {a}_{y , 1} \\ - {a}_{x , 1} sin α + {a}_{z , 1} cos α\end{matrix} ] .$$

In some embodiments, as shown in FIG. 6B, the first rotation angle determined at the current time instance may be β, then after obtaining the rotation-converted acceleration data (a_{x,1} cos α+a_{z,1} sin α, a_{v,1}, −a_{x,1} sin α+a_{z,1} cos α), the rotation-converted acceleration data may be rotated around the X axis of the accelerometer based on the first rotation angle β to correct, through rotation, the rotation-converted acceleration data, to obtain corrected acceleration data. The detailed rotation conversion may be implemented as follows:

$$[ \begin{matrix}{a}_{x , 3} \\ {a}_{y , 3} \\ {a}_{z , 3}\end{matrix} ] = [ \begin{matrix}1 & 0 & 0 \\ 0 & cos β & - sin β \\ 0 & sin β & cos β\end{matrix} ] [ \begin{matrix}{a}_{x , 1} cos α + {a}_{z , 1} sin α \\ {a}_{y , 1} \\ - {a}_{x , 1} sin α + {a}_{z , 1} cos α\end{matrix} ] .$$

In another practical method: rotating the acceleration data around the X axis of the accelerometer to convert into rotation-converted acceleration data; and rotating the rotation-converted acceleration data around the Y axis of the accelerometer based on the first rotation angle to obtain corrected acceleration data.

In some embodiments, the acceleration data output by the accelerometer at the current time instance may be (a_{x,1}, a_{y,1}, a_{z,1}), the first rotation angle determined at the current time instance may be α, then the acceleration data may be rotated around the X axis of the accelerometer based on the first rotation angle a to obtain rotation-converted acceleration data (a_{x,1}, a_{y,1} cos α−a_{z,1} sin α, a_{y,1} sin α+a_{z,1} cos α). The detailed rotation conversion may be implemented as follows:

$$[ \begin{matrix}{a}_{x , 2} \\ {a}_{y , 2} \\ {a}_{z , 2}\end{matrix} ] = [ \begin{matrix}1 & 0 & 0 \\ 0 & cos α & - sin α \\ 0 & sin α & cos α\end{matrix} ] [ \begin{matrix}{a}_{x , 1} \\ {a}_{y , 1} \\ {a}_{z , 1}\end{matrix} ] = [ \begin{matrix}{a}_{x , 1} \\ {a}_{y , 1} cos α - {a}_{z , 1} sin α \\ {a}_{y , 1} sin α + {a}_{z , 1} cos α\end{matrix} ] .$$

In some embodiments, the first rotation angle determined at the current time instance is β. After obtaining the rotation-corrected (or rotation-converted) acceleration data (a_{x,1}, a_{y,1} cos α+a_{z,1} sin α, a_{y,1}(−sin α)+a_{z,1} cos α), the rotation-converted acceleration data may be rotation-corrected by rotating the rotation-converted acceleration data around the Y axis of the accelerometer based on the first rotation angle β to obtain rotation-corrected acceleration data. The detailed rotation conversion may be implemented as follows:

$$[ \begin{matrix}{a}_{x , 3} \\ {a}_{y , 3} \\ {a}_{z , 3}\end{matrix} ] = [ \begin{matrix}cos β & 0 & sin β \\ 0 & 1 & 0 \\ - sin β & 0 & cos β\end{matrix} ] [ \begin{matrix}{a}_{x , 1} \\ {a}_{y , 1} cos α - {a}_{z , 1} sin α \\ {a}_{y , 1} sin α + {a}_{z , 1} cos α\end{matrix} ] .$$

In a second practical method: when the flight velocity at the current time instance is not within a predetermined range, a rotation angle may be determined based on a predetermined rotation angle correction amount. The acceleration data may be rotation-corrected based on the rotation angle to obtain corrected acceleration data. Each time the acceleration data are rotation-corrected, the rotation angle may be determined based on the predetermined rotation angle correction amount. The flight velocity of the aircraft in the horizontal direction at the current time instance may include a flight velocity of the aircraft in the X axis direction and a flight velocity of the aircraft in the Y axis direction at the current time instance.

In some embodiments, a first rotation angle at the current time instance may be determined based on the predetermined rotation angle correction amount, and a second rotation angle at the current time instance may be determined based on the predetermined rotation angle correction amount; the acceleration data may be rotation-corrected based on the first rotation angle and the second rotation angle to obtain corrected acceleration data.

Next, detailed descriptions will be provided for the process of determining the first rotation angle at the current time instance based on the predetermined rotation angle correction amount and determining the second rotation angle at the current time instance based on the predetermined rotation angle correction amount:

The first rotation angle at the current time instance may be determined based on the predetermined rotation angle correction amount and a first rotation angle at a previous time instance prior to the current time instance; the second rotation angle at the current time instance may be determined based on the predetermined rotation angle correction amount and a second rotation angle at the previous time instance prior to the current time instance. For example, the predetermined rotation angle correction amount may be αₑᵣᵣ, and at time instance k=0, the flight velocity Vₓ₀ in the X axis direction, the flight velocity V_{y0} in the Y axis direction, and the acceleration data output by the accelerometer at the current time instance may be obtained. When the flight velocities Vₓ₀ and V_{y0} at the current time instance are not within the predetermined range, the first rotation angle may be αₓ₀=αₑᵣᵣ, the second rotation angle may be α_{y0}=αₑᵣᵣ. The acceleration data may be rotation-converted based on the first rotation angle αₓ₀ and the second rotation angle α_{y0} to obtain corrected acceleration data. The flight velocity may be controlled based on the corrected acceleration data such that the flight velocity at time instance k=1 is smaller than the flight velocity at the current time instance.

At time instance k=1, a flight velocity Vₓ₁ in the X axis direction, a flight velocity V_{y1} in the Y axis direction, and the acceleration data output by the accelerometer at the current time instance may be obtained. When the flight velocities Vₓ₁ and V_{y1} at the current time instance are not within the predetermined range, the first rotation angle may be a sum of a predetermined rotation angle correction amount and the first rotation angle at the previous time instance k=0, i.e., αₓ₁=αₓ₀+αₑᵣᵣ. The second rotation angle is a sum of the rotation angle at k=0 time instance and the second rotation angle correction amount at the current time instance, i.e., α_{y1}=α_{y0}+αₑᵣᵣ. The acceleration data may be rotation-converted based on the first rotation angle αₓ₁ and the second rotation angle α_{y1} to obtain corrected acceleration data. The flight velocity may be controlled based on the corrected acceleration data such that the flight velocity at k=2 time instance is smaller than the flight velocity at the current time instance.

At k=2 time instance, a flight velocity Vₓ₂ in the X axis direction, a flight velocity V_{y2} in the Y axis direction, and acceleration data output by the accelerometer at the current time instance may be obtained. When the flight velocities Vₓ₂ and V_{y2} at the current time instance are not within the predetermined range, the first rotation angle may be a sum of the rotation angle at time instance k=1 and a first rotation angle correction amount at the current time instance, i.e., αₓ₂=αₓ₁+αₑᵣᵣ. The second rotation angle may be a sum of the rotation angle at k=1 time instance and a second rotation angle correction amount at the current time instance, i.e., α_{y2}=α_{y1}+αₑᵣᵣ. The acceleration data may be rotation-converted based on the first rotation angle αₓ₂ and the second rotation angle α_{y2} to obtain corrected acceleration data. The flight velocity may be controlled based on the corrected acceleration data such that the flight velocity at k=3 time instance is smaller than the flight velocity at the current time instance.

The same process may be repeated until the flight velocity at the next time instance is within the predetermined range, i.e., until the flight velocity at the next time instance is smaller than the predetermined velocity value.

In some embodiments, the acceleration data may be rotation-corrected based on the first rotation angle and the second rotation angle to obtain the corrected acceleration data. The detailed implementation may refer to the above relevant descriptions, which are not repeated.

Step S604: controlling a flight velocity of the aircraft in the horizontal direction based on the corrected acceleration data, such that a flight velocity of the aircraft in the horizontal direction at a next time instance is smaller than the flight velocity of the aircraft in the horizontal direction at the current time instance.

In some embodiments, the entity for executing step S604 and the execution principle may be the same as those of step S204 shown in FIG. 2. Thus, descriptions of step S604 can refer to the descriptions of step S204, which are not repeated.

According to the course correction method of the present disclosure, acceleration of the aircraft may be corrected based on the flight velocity at the current time instance. After obtaining the corrected acceleration data, the flight velocity of the aircraft in the horizontal direction may be controlled based on the corrected acceleration data, such that a flight velocity of the aircraft in the horizontal direction at a next time instance is smaller than the flight velocity of the aircraft in the horizontal direction at the current time instance. The disclosed method may optimize the course of the aircraft during a course movement, can effectively reduce the occurrence of course deviation while adjusting the course of the aircraft, and improving the flexibility and safety of the aircraft in various applications.

In some embodiments, in the course correction method of the present disclosure, during the process of adjusting the course, the course correction steps may be repeatedly executed until the velocity of the aircraft in the horizontal direction is within a predetermined range. The disclosed method may continuously optimize the course during a course movement of the aircraft, until it reached or is close to an ideal state.

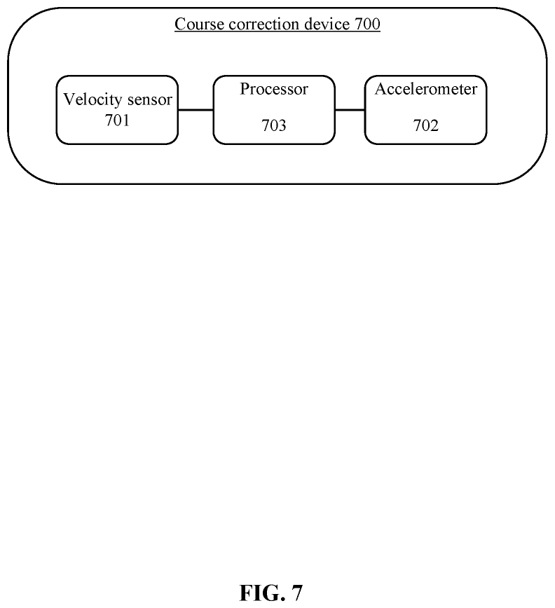

The present disclosure provides a course correction device (or a device for correcting a course of an aircraft). FIG. 7 is a schematic diagram of a course correction device. As shown in FIG. 7, a course correction device 700 may include a velocity sensor 701, an accelerometer 702, and a processor 703.

In some embodiments, the velocity sensor 701 may be configured to obtain a flight velocity of the aircraft in the horizontal direction during a course movement of the aircraft, and transmit the flight velocity to the processor 703.

In some embodiments, the accelerometer 702 may be configured to obtain acceleration data of the aircraft during the course movement of the aircraft, and transmit the acceleration data to the processor 703.

In some embodiments, the processor 703 may be configured to correct the acceleration data based on the flight velocity at the current time instance to obtain corrected acceleration data; control the flight velocity of the aircraft in the horizontal direction based on the corrected acceleration data, such that a flight velocity of the aircraft in the horizontal direction at a next time instance is smaller than the flight velocity of the aircraft in the horizontal direction at the current time instance.

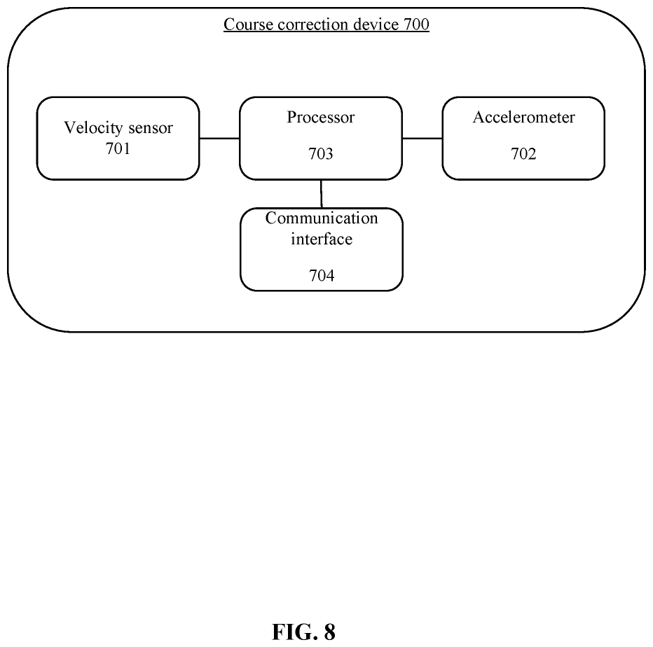

In some embodiments, if the course correction device is implemented in an unmanned aircraft, on the basis of FIG. 7, as shown in FIG. 8, the course correction device may also include a communication interface 704. The communication interface 704 may be configured to receive a course control command transmitted by a control terminal.

Correspondingly, the processor 703 may be configured to control the aircraft to perform the course movement based on the course control command.

In some embodiments, the control terminal may include one or more of a remote controller, a smart cell phone, a tablet, a ground-based control station, a laptop, a watch, a wristband, or a combination thereof. In some embodiments, the unmanned aircraft may be controlled from the control terminal located at the ground.

In some embodiments, when the processor 703 corrects the acceleration data based on the flight velocity at the current time instance to obtain the corrected acceleration data, the processor 703 may be configured to:

correct the acceleration data to obtain corrected acceleration data if the flight velocity at the current time instance is not within a predetermined range.

In some embodiments, the detailed principle and implementation of the course correction device may be similar to those discussed above in connection with the embodiment shown in FIG. 2, which are not repeated.

In some embodiments, the course correction device of the present disclosure may obtain a flight velocity of the aircraft in the horizontal direction and acceleration data of the aircraft at the current time instance during a course movement of the aircraft. The course correction device may correct the acceleration of the aircraft based on the flight velocity at the current time instance to obtain corrected acceleration data. The course correction device may control the flight velocity of the aircraft in the horizontal direction based on the corrected acceleration data, such that a flight velocity of the aircraft in the horizontal direction at a next time instance is smaller than the flight velocity of the aircraft in the horizonal direction at the current time instance. Through the above-described course correction process, during the course movement of the aircraft, a velocity of the aircraft in the horizontal direction may be effectively reduced, i.e., the radius with which the aircraft circles around a location point may be reduced, such that the aircraft may maintain its location unchanged during the course movement. The disclosed method and device can enhance the performance of the aircraft in maintaining its location unchanged and only adjusting the course, thereby improving the flexibility and safety of the aircraft in various applications.

The present disclosure provides a course correction device. On the basis of the technical solutions shown in FIG. 7 and FIG. 8, the velocity sensor 701 may obtain a flight velocity of the aircraft in the horizontal direction at the current time instance during a course movement of the aircraft. For example, the velocity sensor 701 may obtain a velocity of the aircraft in the X axis direction and a velocity of the aircraft in the Y axis direction in the aircraft body coordinate system.

Correspondingly, the processor 703 may be configured to correct the acceleration data to obtain corrected acceleration data when the flight velocity at the current time instance is not within a predetermined range. For example, if the velocity of the aircraft in the X axis direction and the velocity of the aircraft in the Y axis direction at the current time instance are not within the predetermined range, the processor 703 may correct the acceleration data to obtain corrected acceleration data.

In some embodiments, based on the velocity sensor 701 and the processor 703, when the processor 703 corrects the acceleration data to obtain corrected acceleration data when the flight velocity at the current time instance is not within the predetermined range:

the processor 703 may be configured to determine a rotation angle when the flight velocity at the current time instance is not within the predetermined range, and rotate the acceleration data based on the rotation angle to obtain corrected acceleration data.

In some embodiments, when the processor 703 determines the rotation angle and corrects the acceleration data based on the rotation angle to obtain corrected acceleration data, the processor 703 is configured to:

determine the rotation angle at the current time instance based on a flight velocity of the aircraft in the horizontal direction at the current time instance, and rotation-correct the acceleration data based on the rotation angle to obtain corrected acceleration data.

In some embodiments, when the processor 703 determines the rotation angle at the current time instance based on the flight velocity of the aircraft in the horizontal direction at the current time instance, and rotation-correct the acceleration data based on the rotation angle to obtain the corrected acceleration data, the processor 703 is configured to:

determine a first rotation angle at the current time instance based on a velocity in the X axis direction in the aircraft body coordinate system, and determine a second rotation angle at the current time instance based on a velocity in the Y axis direction in the aircraft body coordinate system; and

rotate the acceleration data based on the first rotation angle and the second rotation angle to obtain corrected acceleration data.

In some embodiments, when the processor 703 determines the first rotation angle at the current time instance based on the velocity in the X axis direction in the aircraft body coordinate system, and determines the second rotation angle at the current time instance based on the velocity in the Y axis direction in the aircraft body coordinate system, the processor 703 is configured to:

determine a first rotation angle correction amount at the current time instance based on the velocity in the X axis direction in the aircraft body coordinate system, and determine the first rotation angle at the current time instance based on the first rotation angle correction amount and the first rotation angle at a previous time instance prior to the current time instance; and

determine a second rotation angle correction amount at the current time instance based on the velocity in the Y axis direction in the aircraft body coordinate system, and determine the second rotation angle based on the second rotation angle correction amount and the second rotation angle at the previous time instance prior to the current time instance.

In some embodiments, after determining the first rotation angle and the second rotation angle, the processor 703 may rotate the acceleration data based on the first rotation angle and the second rotation angle to obtain corrected acceleration data.

In some embodiments, when the processor 703 obtains the corrected acceleration data based on the first rotation angle and the second rotation angle, the processor 703 may be configured to:

rotate the acceleration data around the Y axis of the accelerometer for the first rotation angle to convert into rotation-converted acceleration data; and rotate the rotation-converted acceleration data around the X axis of the accelerometer based on the second rotation angle to obtain the corrected acceleration data; or

rotate the acceleration data around the X axis of the accelerometer based on the second rotation angle to convert into rotation-converted acceleration data; and rotate the rotation-converted acceleration data around the Y axis of the accelerometer for the first rotation angle to obtain the corrected acceleration data.

The detailed principle and implementation of the course correction device of the present embodiment are similar to those of the velocity sensor, processor, and accelerometer of the embodiments shown in FIG. 4-FIG. 6, which are not repeated.

The course correction device of the present disclosure may obtain a flight velocity of the aircraft in the horizontal direction and acceleration data of the aircraft at the current time instance during a course movement of the aircraft. The course correction device may correct the acceleration of the aircraft based on the flight velocity at the current time instance to obtain corrected acceleration data. The course correction device may control the flight velocity of the aircraft in the horizontal direction based on the corrected acceleration data, such that a flight velocity of the aircraft in the horizontal direction at a next time instance is smaller than the flight velocity of the aircraft in the horizontal direction at the current time instance. Through the above course correction process, during the course movement of the aircraft, the velocity of the aircraft in the horizontal direction can be effectively reduced, i.e., the radius with which the aircraft circles around a location point may be reduced, such that the aircraft may maintain its location unchanged during the course movement. As a result, the performance of the unmanned aircraft in maintaining the location unchanged and only adjusting the course may be enhanced, and the flexibility and safety of the aircraft in the various applications may be improved.

In some embodiments, during the course movement of the aircraft, the velocity sensor 701, the accelerometer 702, and the processor 703 may be configured to repeat the above steps until the velocity of the aircraft in the horizontal direction is within the predetermined range. The disclosed course correction method and device may continuously optimize the course during the course movement until it reaches or is closed to an ideal state.

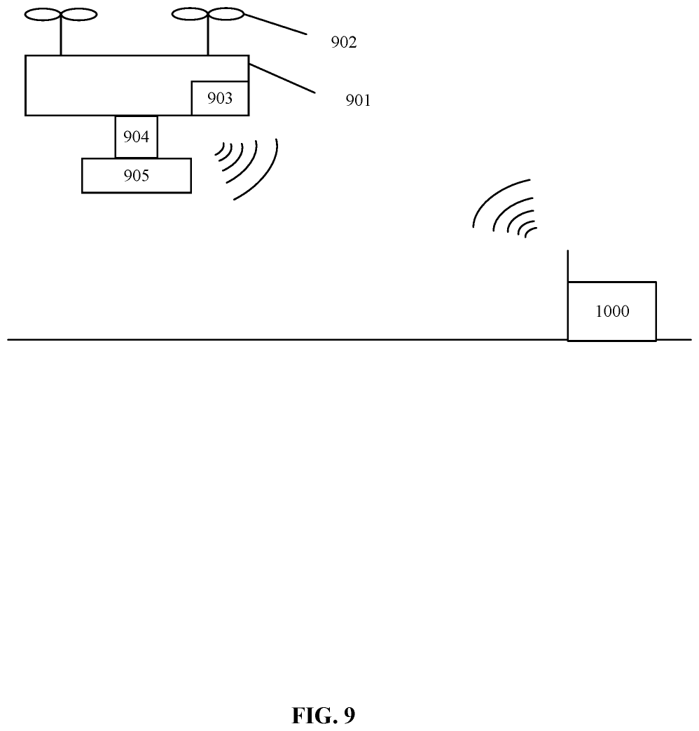

The present disclosure provides an aircraft. The aircraft may be an unmanned aircraft (e.g., an unmanned aerial vehicle (“UAV”)). FIG. 9 is a schematic diagram of an unmanned aircraft. As shown in FIG. 9, the unmanned aircraft may include: an aircraft body 901, a propulsion system 902, and a course correction device 903. The propulsion system 902 may be mounted to the aircraft body 901 and may be configured to provide a flight propulsion. The course correction device 903 may be any of the course correction device disclosed herein. The principle and implementation of the course correction device 903 may refer to the above descriptions of the various embodiments, which are not repeated.

In some embodiments, the propulsion system may include one or more of a propeller, a motor, and an electric speed control. The unmanned aircraft may also include a gimbal 904 and an imaging device 905. The imaging device 905 may be carried by the main body or frame of the unmanned aircraft through the gimbal 904. The imaging device 905 may be configured to capture images and/or videos during a flight of the unmanned aircraft. The imaging device 905 may include one or more of a multispectral imaging device, a hyperspectral imaging device, a visible light imaging device, or an infrared imaging device, etc. The gimbal 904 may be a multi-axis transmission and stabilization system. The motor of the gimbal may compensate for the imaging angle of the imaging device 905 through adjusting a rotation angle of a rotation axis. The gimbal may include a suitable damping structure to reduce or eliminate the shaking of the imaging device 905. In some embodiments, the unmanned aircraft may receive a control command from a control terminal 1000, such as a mounting error detection command, and may control the unmanned aircraft to execute corresponding actions based on the control command.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated unit may be realized using hardware or a combination of hardware and software.

The integrated units realized through software functional units may be stored in a non-transitory computer-readable storage medium. The software functional units stored in a storage medium may include a plurality of instructions configured to instruct a computing device (which may be a personal computer, a server, or a network device, etc.) or a processor to execute some or all of the steps of the various embodiments of the disclosed method. The storage medium may include any suitable medium that can store program codes or instructions, such as at least one of a U disk (e.g., flash memory disk), a mobile hard disk, a read-only memory (“ROM”), a random access memory (“RAM”), a magnetic disk, or an optical disc.

A person having ordinary skill in the art can appreciate that for convenience and simplicity, the above descriptions described the division of the functioning units. In practical applications, the disclosed functions may be realized by various functioning units. For example, in some embodiments, the internal structure of a device may be divided into different functioning units to realize all or part of the above-described functions. The detailed operations and principles of the device are similar to those described above, which are not repeated.

The above embodiments are only examples of the present disclosure, and do not limit the scope of the present disclosure. Although the technical solutions of the present disclosure are explained with reference to the above-described various embodiments, a person having ordinary skills in the art can understand that the various embodiments of the technical solutions may be modified, or some or all of the technical features of the various embodiments may be equivalently replaced. Such modifications or replacement do not render the spirit of the technical solutions falling out of the scope of the various embodiments of the technical solutions of the present disclosure.

What is claimed is:

1. A method for correcting a course of an aircraft, comprising:
obtaining a flight velocity of the aircraft in a horizontal direction at a current time instance and acceleration data of the aircraft at the current time instance during a course movement of the aircraft;
correcting the acceleration data based on the flight velocity in the horizontal direction at the current time instance to obtain corrected acceleration data; and
controlling a flight velocity of the aircraft in the horizontal direction based on the corrected acceleration data.

2. The method of claim 1, further comprising:
receiving a course control command transmitted by a control terminal; and
controlling the aircraft to perform a course movement based on the course control command.

3. The method of claim 1, wherein correcting the acceleration data based on the flight velocity in the horizontal direction at the current time instance to obtain the corrected acceleration data comprises:
correct the acceleration data to obtain the corrected acceleration data if the flight velocity in the horizontal direction at the current time instance is not within a predetermined range.

4. The method of claim 3,
wherein the flight velocity of the aircraft in the horizontal direction comprises a velocity of the aircraft in an X axis direction and a velocity of the aircraft in a Y axis direction in an aircraft body coordinate system, and
wherein correcting the acceleration data to obtain the corrected acceleration data if the flight velocity in the horizontal direction at the current time instance is not within the predetermined range comprises:
correcting the acceleration data to obtain the corrected acceleration data if the velocity of the aircraft in the X axis direction and the velocity of the aircraft in the Y axis direction are not within the predetermined range.

5. The method of claim 3, wherein correcting the acceleration data to obtain the corrected acceleration data if the flight velocity in the horizontal direction at the current time instance is not within the predetermined range comprises:
if the flight velocity in the horizontal direction at the current time instance is not within the predetermined range, determining a rotation angle and rotating the acceleration data based on the rotation angle to obtain the corrected acceleration data.

6. The method of claim 5, wherein determining the rotation angle and rotating the acceleration data based on the rotation angle to obtain the corrected acceleration data comprises:
determining the rotation angle at the current time instance based on the flight velocity of the aircraft in the horizontal direction at the current time instance, and rotating the acceleration data based on the rotation angle to obtain the corrected acceleration data.

7. The method of claim 6, wherein rotating the acceleration data based on the rotation angle to obtain the corrected acceleration data comprises:
determining a first rotation angle at the current time instance based on a velocity in an X axis direction in an aircraft body coordinate system, and determining a second rotation angle at the current time instance based on a velocity in a Y axis direction in the aircraft body coordinate system; and
rotating the acceleration data based on the first rotation angle and the second rotation angle to obtain the corrected acceleration data.

8. The method of claim 7, wherein determining the first rotation angle at the current time instance based on the velocity in the X axis direction in the aircraft body coordinate system, and determining the second rotation angle at the current time instance based on the velocity in the Y axis direction in the aircraft body coordinate system comprises:
determining a first rotation angle correction amount at the current time instance based on the velocity in the X axis direction in the aircraft body coordinate system, and determining the first rotation angle at the current time instance based on the first rotation angle correction amount and a first rotation angle at a previous time instance prior to the current time instance; and
determining a second rotation angle correction amount at the current time instance based on the velocity in the Y axis direction in the aircraft body coordinate system, and determining the second rotation angle at the current time instance based on the second rotation angle correction amount and a second rotation angle at the previous time instance prior to the current time instance.

9. The method of claim 7, wherein rotating the acceleration data based on the first rotation angle and the second rotation angle to obtain the corrected acceleration data comprises:
rotating the acceleration data around an Y axis of an accelerometer for the first rotation angle to obtain rotation-converted acceleration data; and
rotating the rotation-converted acceleration data around an X axis of the accelerometer based on the second rotation angle to obtain the corrected acceleration data.

10. The method of claim 7, wherein rotating the acceleration data based on the first rotation angle and the second rotation angle to obtain the corrected acceleration data comprises:
rotating the acceleration data around an X axis of an accelerometer based on the second rotation angle to obtain rotation-converted acceleration data; and
rotating the rotation-converted acceleration data around a Y axis of the accelerometer for the first rotation angle to obtain the corrected acceleration data.

11. A device for correcting a course of an aircraft, comprising:
a velocity sensor;
an accelerometer; and
a processor,
wherein the velocity sensor is configured to obtain a flight velocity of the aircraft in a horizontal direction at a current time instance and transmit the flight velocity to the processor during a course movement of the aircraft,
wherein the accelerometer is configured to obtain acceleration data of the aircraft at the current time instance and transmit the acceleration data to the processor during the course movement of the aircraft, and
wherein the processor is configured to:
correct the acceleration data based on the flight velocity of the aircraft in the horizontal direction at the current time instance to obtain corrected acceleration data; and
control a flight velocity of the aircraft in the horizontal direction based on the corrected acceleration data.

12. The device of claim 11, further comprising a communication interface configured to receive a course control command transmitted by a control terminal,
wherein the processor is configured to control the course movement of the aircraft based on the course control command.

13. The device of claim 11, wherein when the processor corrects the acceleration data based on the flight velocity in the horizontal direction at the current time instance to obtain the corrected acceleration data, the processor is configured to:
correct the acceleration data to obtain the corrected acceleration data if the flight velocity in the horizontal direction at the current time instance is not within a predetermined range.

14. The device of claim 13,
wherein the flight velocity of the aircraft in the horizontal direction comprises a velocity of the aircraft in an X axis direction and a velocity of the aircraft in a Y axis direction in an aircraft body coordinate system, and
wherein when the processor corrects the acceleration data to obtain the corrected acceleration data if the flight velocity in the horizontal direction at the current time instance is not within the predetermined range, the processor is configured to:
correct the acceleration data to obtain the corrected acceleration data if the velocity of the aircraft in the X axis direction and the velocity of the aircraft in the Y axis direction in the aircraft body coordinate system are not within the predetermined range.

15. The device of claim 13, wherein when the processor corrects the acceleration data to obtain the corrected acceleration data if the flight velocity in the horizontal direction at the current time instance is not within the predetermined range, the processor is configured to:
determine a rotation angle at the current time instance and rotate the acceleration data based on the correction angle to obtain the corrected acceleration data if the flight velocity in the horizontal direction at the current time instance is not within the predetermined range.

16. The device of claim 15, wherein when the processor determines the rotation angle at the current time instance and rotates the acceleration data based on the correction angle to obtain the corrected acceleration data, the processor is configured to:
determine the rotation angle at the current time instance based on the flight velocity of the aircraft in the horizontal direction at the current time instance, and rotate the acceleration data based on the rotation angle to obtain the corrected acceleration data.

17. The device of claim 16, wherein when the processor determines the rotation angle at the current time instance based on the flight velocity of the aircraft in the horizontal direction at the current time instance, and rotates the acceleration data based on the rotation angle to obtain the corrected acceleration data, the processor is configured to:
determine a first rotation angle at the current time instance based on a velocity in an X axis direction in an aircraft body coordinate system, and determine a second rotation angle at the current time instance based on a velocity in a Y axis direction in the aircraft body coordinate system; and
rotate the acceleration data based on the first rotation angle and the second rotation angle to obtain the corrected acceleration data.

18. The device of claim 16, wherein when the processor determines the first rotation angle at the current time instance based on the velocity in the X axis direction in the aircraft body coordinate system, and determines the second rotation angle at the current time instance based on the velocity in the Y axis direction in the aircraft body coordinate system, the processor is configured to:
determine a first rotation angle correction amount at the current time instance based on the velocity in the X axis direction in the aircraft body coordinate system, and determine the first rotation angle at the current time instance based on the first rotation angle correction amount and a first rotation angle at a previous time instance prior to the current time instance; and
determine a second rotation angle correction amount at the current time instance based on the velocity in the Y axis direction in the aircraft body coordinate system, and determine the second rotation angle at the current time instance based on the second rotation angle correction amount and a second rotation angle at the previous time instance prior to the current time instance.

19. The device of claim 17, wherein when the processor rotates the acceleration data based on the first rotation angle and the second rotation angle to obtain the corrected acceleration data, the processor is configured to:
rotate the acceleration data around a Y axis of the accelerometer based on the first rotation angle to obtain rotation-converted acceleration data; and
rotate the rotation-converted acceleration data around an X axis of the accelerometer based on the second rotation angle to obtain the corrected acceleration data.

20. The device of claim 17, wherein when the processor rotates the acceleration data based on the first rotation angle and the second rotation angle to obtain the corrected acceleration data, the processor is configured to:
rotate the acceleration data around an X axis of the accelerometer based on the second rotation angle to obtain rotation-converted acceleration data; and
rotate the rotation-converted acceleration data around a Y axis of the accelerometer based on the first rotation angle to obtain the corrected acceleration data.
